(19) United States
(12) Patent Application Publication
(10) Pub. No.: US 2018/0365086 A1
(43) Pub. Date: Dec. 20, 2018

(54) Method for Processing Data Collected by Touch Panel, and Terminal Device

(71) Applicant: Huawei Technologies Co., Ltd., Shenzhen (CN)

(72) Inventors: Guanghua Zhong, Shenzhen (CN); Bin Pan, Hangzhou (CN); Weijian Yang, Hangzhou (CN)

(21) Appl. No.: 16/121,374

(22) Filed: Sep. 4, 2018

Related U.S. Application Data
(63) Continuation of application No. PCT/CN2017/075161, filed on Feb. 28, 2017.

(30) Foreign Application Priority Data
Mar. 4, 2016 (CN) 201610124713.8

(51) Int. Cl. G06F 9/54; G06F 13/42; G06F 1/32; G06F 3/041

(52) U.S. Cl. CPC G06F 9/542; G06F 3/0418; G06F 1/3231; G06F 13/4282

(57) ABSTRACT

A method and a terminal device, where the method is applied to process data collected by a touch panel to reduce power consumption of the terminal. The touch panel communicates with an application processor using a micro control unit (MCU) through a dedicated channel. The method includes obtaining, by the MCU, touch data from the touch panel, pre-processing the touch data, and sending the pre-processed touch data to the application processor. The MCU pre-processes the touch data of the touch panel to filter ineffective touch data, and then sends effective touch data to the application processor. Therefore, the application processor is not wakened up by an ineffective touch event when the application processor enters a sleep state, thereby reducing load of the application processor, and reducing power consumption of a device.

### CROSS-REFERENCE TO RELATED APPLICATIONS

This application is a continuation of International Patent Application No. PCT/CN2017/075161 filed on Feb. 28, 2017, which claims priority to Chinese Patent Application No. 201610124713.8 filed on Mar. 4, 2016. The disclosures of the aforementioned applications are hereby incorporated by reference in their entireties.

### TECHNICAL FIELD

The present disclosure relates to the touch panel field, and in particular, to a method for processing data collected by a touch panel, and a terminal device.

### BACKGROUND

As a new human-machine interaction carrier, a touch panel is widely applied to various intelligent terminal products. The touch panel is a frequently-used module of an intelligent terminal such as a mobile phone, and therefore, user experience of the touch panel is crucial. Power consumption is one of factors that affect user experience.

FIG. 1 shows a processing procedure of touch data of a touch panel. A touch panel driver (or touch driver) in an application processor (also referred to as AP) obtains touch data from the touch panel, and then the touch panel driver reports the touch data to an operating system kernel in the AP. After processing the data, the kernel invokes a display module to display an image by frame.

In this process, the AP needs to process the touch data of the touch panel anytime. Even if the AP has no task, to prevent performance from being affected, the AP cannot enter a deep sleep state. Therefore, load of the AP is relatively heavy, and power consumption of a device is increased.

### SUMMARY

Embodiments of the present disclosure provide a method for processing data collected by a touch panel, and a terminal device such that power consumption of a device can be reduced.

According to a first aspect, an embodiment of the present disclosure provides a method for processing data collected by a touch panel. A touch panel communicates with an AP using a micro control unit (MCU), and the method includes obtaining, by the MCU, touch data from the touch panel, pre-processing the touch data, and sending the pre-processed touch data to the AP.

In this embodiment of the present disclosure, the touch panel communicates with the AP using the MCU, instead of directly communicating with the AP. The MCU pre-processes the touch data of the touch panel to filter ineffective touch data, and then sends effective touch data to the AP. Therefore, the MCU can process the touch data of the touch panel anytime when the AP enters a sleep state, and the MCU can filter the touch data such that the AP is not wakened up by an ineffective touch event when the AP enters a sleep state, thereby reducing load of the AP, and reducing power consumption of a device.

With reference to the first aspect, in a first possible implementation of the first aspect, sending, by the MCU, the pre-processed touch data to the AP includes sending, by the MCU, the touch data to the AP using a dedicated touch data channel, where the touch data channel is used to send only the touch data.

In this embodiment of the present disclosure, the touch data is transmitted between the AP and the MCU using the dedicated touch data channel, and is isolated from other data (e.g. non-touch data) such that a touch data transmission delay can be reduced, touch data processing efficiency is improved, and system performance is improved.

With reference to the first aspect or the first possible implementation of the first aspect, in a second possible implementation of the first aspect, pre-processing, by the MCU, the touch data includes pre-processing, by the MCU, the touch data using a first frequency, where the first frequency is greater than a processing frequency of the AP. In an ANDROID system, the system sends a frame synchronization (Vertical Synchronization (VSYNC)) signal (using about a 60 hertz (Hz) frequency) every 16 milliseconds (ms) to trigger the AP to process data, and therefore, the processing frequency of the AP is 60 Hz. A sampling frequency of the touch panel is 120 Hz, the MCU obtains the touch data from the touch panel, and therefore, a frequency for processing the touch data is also 120 Hz. In this case, the first frequency is 120 Hz, and is greater than the processing frequency 60 Hz of the AP.

Further, with reference to the second possible implementation of the first aspect, in a third possible implementation of the first aspect, the MCU determines, using the first frequency, a touch event corresponding to the touch data. In some embodiments, the touch event is any one of a down event, a move event, or an up event. For example, the MCU determines, using the first frequency, that the touch event corresponding to the touch data is a down event, a move event, or an up event. In some other embodiments, the MCU determines, using the first frequency, that the touch event corresponding to the touch data includes multiple events, such as including a down event and an up event or including a down event, a move event, and an up event. In some other embodiments, the touch event may be another event, for example, an event generated by a non-contact gesture.

Therefore, the MCU processes the touch data using a processing frequency greater than that of the AP such that an effective touch event can be recognized in a shorter period, and screen response performance can be improved.

With reference to the third possible implementation of the first aspect, in a fourth possible implementation of the first aspect, in some embodiments, the MCU pre-processes the touch data in one or more of the following manners. The MCU reports the down event and the up event to the AP, for the move event, the MCU determines, using the first frequency, a movement distance corresponding to the move event, and if the movement distance is greater than a first preset threshold in a system, reports the move event to the AP, or if the movement distance is less than a first preset threshold in a system, does not report the move event to the AP.

Therefore, in comparison with processing the move event on the AP side, the move event can be rapidly processed on the MCU side, and effective move can be recognized in a shorter period such that a time of determining an effective move event is reduced, and screen response performance can be further improved.

Currently, in a terminal device that supports a screen-off wakeup gesture function, most terminal devices depend on the AP for gesture recognition, and especially a complex gesture. Therefore, in a screen-off state, the AP needs at least one kernel for processing. In this embodiment of the present disclosure, with reference to the first aspect or the third possible implementation of the first aspect, in a fifth possible implementation of the first aspect, the pre-processing, by the MCU, the touch event further includes determining, by the MCU, whether a gesture corresponding to the touch event is the same as a screen-off wakeup gesture preset in a system when the touch panel is in a screen-off state, and if the gesture corresponding to the touch event is the same as the screen-off wakeup gesture preset in the system, sending a wakeup instruction to the AP, or if the gesture corresponding to the touch event is different from the screen-off wakeup gesture preset in the system, not sending a wakeup instruction to the AP.

Therefore, in this embodiment of the present disclosure, in a screen-off state, gesture recognition may be performed without the AP, and the MCU determines the screen-off wakeup gesture. When the gesture is correct, the AP in a sleep state is wakened up, or when the gesture is ineffective, the AP in a sleep state is not wakened up, and the AP may stay in a sleep state. In this way, a case in which power consumption is generated after the AP is wakened up by an incorrect screen-off wakeup gesture is avoided such that overall power consumption of a device can be further reduced.

With reference to any possible implementation of the first aspect, in a sixth possible implementation of the first aspect, the method further includes obtaining, by the MCU, sensing data of a sensor, and pre-processing, by the MCU, the touch data using a first frequency, and sending the pre-processed touch data to the AP includes determining, by the MCU according to the sensing data, whether the touch event is a misoperation event, and if the touch event is not a misoperation event, sending the touch event to the AP, or if the touch event is a misoperation event, not sending the touch event to the AP.

In this way, the MCU can pre-process the touch event of the touch panel using the sensing data of the sensor in order to filter a misoperation event. The AP is not wakened up by a misoperation to some extent, that is, a case in which power consumption is generated after the AP is wakened up by a misoperation is avoided. Therefore, overall power consumption of the AP is effectively reduced, and power consumption of the terminal device is reduced.

With reference to the sixth possible implementation of the first aspect, in a seventh possible implementation of the first aspect, the sensor is a light sensor, and determining, by the MCU according to the sensing data, whether the touch event is a misoperation event includes when the touch panel is in a screen-off state, determining, by the MCU, whether illuminance measured by the light sensor is greater than a second preset threshold, and if the illuminance is not greater than the second preset threshold, determining that the touch event is a misoperation event.

Optionally, before performing the step of distinguishing the touch event in the third possible implementation of the first aspect, the MCU first determines, according to the sensing data, whether a touch operation is a misoperation, and if the touch operation is a misoperation, does not process the touch data, such as subsequent distinguishing of a touch event, and does not report the touch data to the AP.

Further, if the touch panel is in a screen-off state, the MCU determines whether illuminance measured by the light sensor is greater than a second preset threshold, and if the illuminance is not greater than the second preset threshold, determines that an operation corresponding to the touch data obtained by the MCU from the touch panel is a misoperation operation.

According to a second aspect, an embodiment of the present disclosure provides a terminal device, and the terminal device includes a touch panel, an MCU, and an AP, where the AP is electrically connected to the MCU, and the touch panel is electrically connected to the MCU, the touch panel is configured to collect touch data, the MCU is configured to obtain the touch data, pre-process the touch data, and send the pre-processed touch data to the AP, and AP is configured to perform event response according to the touch data sent by the MCU.

With reference to any possible implementation of the second aspect, in a first possible implementation of the second aspect, optionally, the application processor is electrically connected to the MCU using a peripheral bus.

With reference to any possible implementation of the second aspect, in a second possible implementation of the second aspect, the touch panel is electrically connected to the MCU using an inter-integrated circuit bus (I²C).

Further, in a third possible implementation of the second aspect, the terminal device further includes a touch data channel, the touch data channel is electrically connected to a peripheral bus, and the touch data channel is used for data communication only between the MCU and the AP, and the MCU is further configured to send the touch data to the AP using the touch data channel.

Further, in a fourth possible implementation of the second aspect, when pre-processing the touch data, the MCU is further configured to pre-process the touch data using a first frequency, where the first frequency is greater than a processing frequency of the AP.

With reference to the fourth possible implementation of the second aspect, in a fifth possible implementation of the second aspect, when pre-processing the touch data using the first frequency, the MCU is further configured to determine, using the first frequency, a touch event corresponding to the touch data, where the touch event is one or more of a down event, a move event, or an up event.

With reference to the fourth possible implementation of the second aspect, in a sixth possible implementation of the second aspect, after determining, using the first frequency, the touch event corresponding to the touch data, the MCU is further configured to if the event corresponding to the touch data is a move event, determine, using the first frequency, a movement distance corresponding to the move event, and if the movement distance is greater than a first preset threshold in a system, send the move event to the AP, or if the movement distance is less than a first preset threshold in a system, not send the move event to the AP.

With reference to the second aspect or the fourth possible implementation of the second aspect, in a fifth possible implementation of a seventh aspect, after determining, using the first frequency, the touch event corresponding to the touch data, the MCU is further configured to determine whether a gesture corresponding to the touch event is the same as a screen-off wakeup gesture preset in a system when the touch panel is in a screen-off state, and if the gesture corresponding to the touch event is the same as the screen-off wakeup gesture preset in the system, send a wakeup instruction to the AP, or if the gesture corresponding to the touch event is different from the screen-off wakeup gesture preset in the system, not send a wakeup instruction to the AP.

With reference to any possible implementation of the second aspect, in an eighth possible implementation of the second aspect, the MCU is further configured to obtain sensing data, and the MCU is further configured to determine, according to the sensing data, whether the touch event is a misoperation event, and when the touch event is not a misoperation event, send the touch event to the AP, or when the touch event is a misoperation event, not send the touch event to the AP.

With reference to the eighth possible implementation of the second aspect, in a ninth possible implementation of the second aspect, when determining, according to the sensing data, whether the touch event is a misoperation event, the MCU is further configured to when the touch panel is in a screen-off state, determine whether illuminance measured by a light sensor is greater than a second preset threshold, and if the illuminance is not greater than the second preset threshold, determine that the touch event is a misoperation event.

With reference to the second aspect, or the first possible implementation of the second aspect to the fourth possible implementation of the second aspect, in a tenth possible implementation of the second aspect, the MCU is further configured to obtain sensing data, and when pre-processing the touch data and sending the pre-processed touch data to the AP, the MCU is further configured to determine, according to the sensing data, whether an operation corresponding to the touch data is a misoperation, and if the operation is a misoperation, not process the touch data, such as subsequent distinguishing of a touch event, and not report the touch data to the AP.

Optionally, when determining, according to the sensing data, whether the operation corresponding to the touch data is a misoperation, the MCU is further configured to when the touch panel is in a screen-off state, determine whether illuminance measured by a light sensor is greater than a second preset threshold, and if the illuminance is not greater than the second preset threshold, determine that the operation corresponding to the touch data obtained by the MCU from the touch panel is a misoperation.

With reference to any possible implementation of the second aspect, in some specific implementations, the MCU is a low function sensor hub coprocessor.

In this manner, a sensor hub in a terminal device in the other approaches can implement a function implemented by the MCU in this embodiment of the present disclosure.

According to a third aspect, an embodiment of the present disclosure provides a processor, and the processor includes a touch data obtaining module configured to obtain touch data from a touch panel, where the touch panel is electrically connected to the processor, a touch data pre-processing module configured to pre-process the touch data, and a touch data sending module configured to send the pre-processed touch data to an AP, where the AP is electrically connected to the processor.

With reference to the third aspect, in a first possible implementation of the third aspect, the touch data sending module is further configured to send a touch event to the AP using a touch data channel, where the touch data channel is used to send only the touch data.

With reference to the third aspect or the first possible implementation of the third aspect, in a second possible implementation of the third aspect, the touch data pre-processing module is further configured to pre-process the touch data using a first frequency, where the first frequency is greater than a processing frequency of the AP.

With reference to the second possible implementation of the third aspect, in a third possible implementation of the third aspect, the touch data pre-processing module is further configured to determine, using the first frequency, a touch event corresponding to the touch data, where the touch event is one or more of a down event, a move event, or an up event.

With reference to the third possible implementation of the third aspect, in a fourth possible implementation of the third aspect, the touch data pre-processing module is further configured to determine, using the first frequency, a movement distance corresponding to the move event if the event corresponding to the touch data is a move event, and the touch data sending module is further configured to send the move event to the AP if the movement distance is greater than a first preset threshold in a system, or not send the move event to the AP if the movement distance is less than a first preset threshold in a system.

With reference to the third possible implementation of the third aspect, in a fifth possible implementation of the third aspect, the touch data pre-processing module is further configured to determine whether a gesture corresponding to the touch event is the same as a screen-off wakeup gesture preset in a system when the touch panel is in a screen-off state, and the touch data sending module is further configured to send a wakeup instruction to the AP if the gesture corresponding to the touch event is the same as the screen-off wakeup gesture preset in the system.

With reference to the third possible implementation of the third aspect, in a sixth possible implementation of the third aspect, the processor further includes a sensing data obtaining module configured to obtain sensing data, the touch data pre-processing module is further configured to determine, according to the sensing data, whether the touch event is a misoperation event, and the touch data sending module is further configured to send the touch event to the AP when the touch event is not a misoperation event.

With reference to the sixth possible implementation of the third aspect, in a seventh possible implementation of the third aspect, if a sensor is a light sensor, when determining, according to the sensing data, whether the touch event is a misoperation event, the touch data pre-processing module is further configured to determine whether illuminance measured by the light sensor is greater than a second preset threshold when the touch panel is in a screen-off state, and if the illuminance is not greater than the second preset threshold, determine that the touch event is a misoperation event.

With reference to the third aspect or the second possible implementation of the third aspect, in an eighth possible implementation of the third aspect, the processor further includes a sensing data obtaining module configured to obtain sensing data, and the touch data pre-processing module is further configured to determine, according to the sensing data, whether an operation corresponding to the touch data is a misoperation, and if the operation is a misoperation, not process the touch data, such as subsequent distinguishing of a touch event, and not report the touch data to the AP.

With reference to the sixth possible implementation of the third aspect, in a seventh possible implementation of the third aspect, if a sensor is a light sensor, when determining, according to the sensing data, whether an operation corresponding to the touch data is a misoperation, the touch data pre-processing module is further configured to determine whether illuminance measured by the light sensor is greater than a second preset threshold when the touch panel is in a screen-off state, and if the illuminance is not greater than the second preset threshold, determine that the operation corresponding to the touch data obtained by the MCU from the touch panel is a misoperation.

According to a fourth aspect, an embodiment of the present disclosure further provides a computer storage medium. The medium stores a program, and when the program is executed, some or all steps of any implementation provided in the foregoing method in the present disclosure can be implemented.

According to a fifth aspect, an embodiment of the present disclosure further provides a touch panel data processing apparatus. The apparatus includes one or more function modules that can implement the foregoing method steps. For example, the apparatus includes a function module configured to obtain touch data from a touch panel, a function module configured to pre-process the touch data, and a function module configured to send the pre-processed touch data to the AP.

It can be learned from the foregoing technical solutions that, the solutions in the embodiments of the present disclosure have the following beneficial effects.

In the embodiments of the present disclosure, the touch panel communicates with the AP using the MCU, instead of directly communicating with the AP. The MCU obtains the touch data of the touch panel, pre-processes the touch data to filter ineffective touch data and obtain effective touch data, and sends the effective touch data to the AP. In this way, the MCU can process the touch data of the touch panel anytime when the AP enters a sleep state, and the MCU can filter the touch data. Therefore, in the solutions of the present disclosure, the AP without a task can enter a deep sleep state while system performance is not reduced, thereby reducing load of the AP, and reducing power consumption of a device.

### BRIEF DESCRIPTION OF DRAWINGS

FIG. 1 is a flowchart of a method for processing data collected by a touch panel in the other approaches according to an embodiment of the present disclosure;

FIG. 2 is a schematic diagram of a principle of a hardware structure of a terminal device according to an embodiment of the present disclosure;

FIG. 3 is a schematic diagram of a principle of a hardware structure of a terminal device in which an MCU is a sensor hub coprocessor according to an embodiment of the present disclosure; and

FIG. 4 is a flowchart of a method for processing data collected by a touch panel according to an embodiment of the present disclosure.

### DESCRIPTION OF EMBODIMENTS

Currently, a touch panel is widely applied to various types of terminal devices. The touch panel is not only an input apparatus but also an output apparatus. A user may perform an operation such as tap or slide on a touch panel of a terminal device using a finger such that the touch panel changes content displayed on the touch panel. The touch panel is used in an application scenario, for example, when the user browses pictures in a gallery or plays games.

The touch panel in the embodiments of the present disclosure may be touch panels with different operating principles and different information transmission mediums, including a resistive touch panel, a surface capacitive touch panel, a projected capacitive touch panel, an infrared touch panel, a surface acoustic wave touch panel, a bending wave touch panel, an active digital converter touch panel, and an optical imaging touch panel.

The embodiments of the present disclosure are applied to various terminal devices with a touch panel, including a handheld device, an in-vehicle device, a wearable device, a computing device, and various types of user equipment (UE), for example, a device such as a mobile phone or a tablet computer.

A touch panel controller scans a touch panel at a particular scanning frequency during operation of the touch panel to obtain user touch position data (coordinates of a touch point), and sends the obtained user touch position data to an AP of a terminal device. Then, the AP processes and displays an image according to the touch position data.

User experience of a touch panel mainly includes two aspects, performance and power consumption. Operation smoothness of the touch panel is the most visual performance representation, and power consumption of the touch panel affects a battery life of a device. Performance is in contradiction with power consumption. In a same environment, in the other approaches, it is common to sacrifice performance for the sake of power consumption, or sacrifice power consumption for the sake of performance.

For example, in the other approaches, resampling and interface refreshing are performed in advance in a VSYNC manner in order to improve move performance of a touch panel. VSYNC is a key image processing module in an ANDROID system, and determines a sampling point and a moment of drawing an image. However, because the VSYNC is started in advance, power consumption of a device is increased to some extent. In addition, the VSYNC can start to draw an image only with a move event, and consequently, performance improvement is limited.

For another example, in the other approaches, when a screen is on and an AP does not have a task, power consumption is effectively reduced by enabling some processors to enter a deep sleep state. However, in this case, when a processor in a deep sleep state is wakened up, 10 ms or even a longer time is always required, and consequently, frame freezing is caused, and performance and user experience of the touch panel are reduced. Therefore, to ensure that performance is not affected, a deep sleep state is not allowed.

Therefore, in the other approaches, load of the AP is relatively heavy, and power consumption of the device is large. In addition, due to a performance bottleneck, performance cannot be effectively improved while power consumption is reduced.

An embodiment of the present disclosure provides a method for processing data collected by a touch panel, and a terminal device such that power consumption of a device can be reduced, and performance can be further improved.

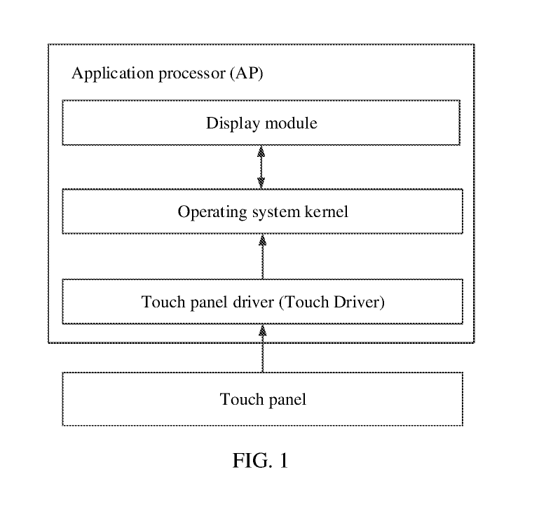

Referring to FIG. 1, FIG. 1 is a schematic diagram of a touch data processing procedure in the other approaches. In a hardware structure of a terminal device in the other approaches, an AP is directly electrically connected to a touch panel, and a touch panel driver in the AP obtains touch data from the touch panel.

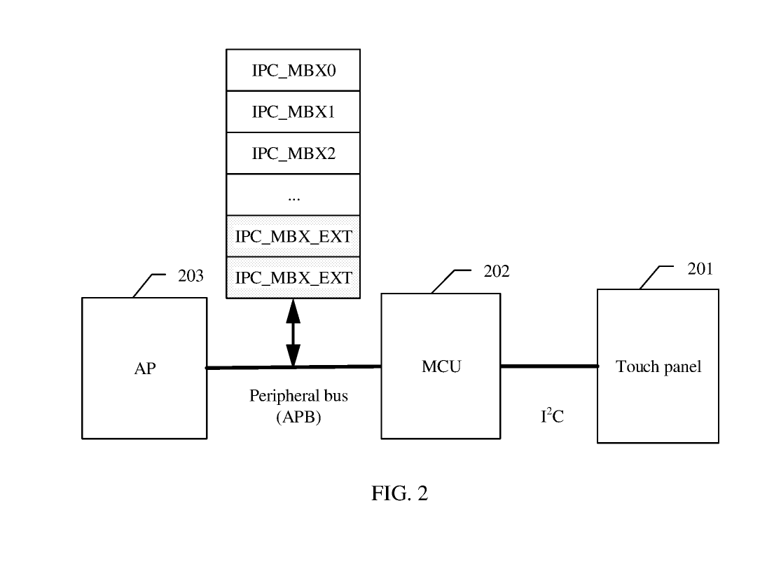

In a hardware structure of a terminal device in this embodiment of the present disclosure, an AP is connected to a touch panel using an MCU. FIG. 2 is a specific schematic diagram of a principle of a hardware structure.

The terminal device in this embodiment of the present disclosure includes a touch panel 201, an MCU 202, and an AP 203. The AP 203 is electrically connected to the MCU 202 using a peripheral bus (or Advanced Peripheral Bus (APB)), and the touch panel 201 is electrically connected to the MCU 202 using an I²C.

It should be noted that in actual application, in a preferred solution, the MCU 202 in this embodiment of the present disclosure is a coprocessor, and extends a kernel processing function by extending an instruction set or by providing a configuration register.

Further, touch data communication is performed between the AP 203 and the MCU 202 using a dedicated touch data channel. The touch data channel is implemented using a register mounted on the peripheral bus. As inter-process communication mailbox extension (IPC_MBX_EXT) shown in FIG. 2, the register is specially configured to control receiving and sending of touch data. Other IPC_MBX0, IPC_MBX1, and IPC_MBX2 are used to control receiving and sending of non-touch data, for example, sensing data. The touch data can be isolated from the non-touch data for transmission using the dedicated touch data channel such that a touch data transmission delay is not reduced, touch data processing efficiency is improved, and system performance is improved.

In the terminal device with this hardware structure, the touch panel 201 is configured to collect touch data. The MCU 202 is configured to obtain the touch data of the touch panel 201, pre-process the touch data, and send the pre-processed touch data to the AP 203. The AP 203 is configured to perform event response according to the touch data sent by the MCU 202, and display a change effect of a triggered object using the touch panel.

Further, the MCU 202 processes, by running a software program, the touch data obtained from the touch panel. Optionally, the software program run on the MCU 202 may include a touch panel driver (Touch Driver) and an event processing module (EventHub) in terms of function.

The touch panel driver is configured to obtain the touch data of the touch panel, calculate the touch data to obtain data such as coordinates of a touch point, pressure, and a finger identifier (ID), and send the touch data to the event processing module. The event processing module is configured to receive the touch data sent by the touch panel driver, pre-process the touch data, and send the pre-processed touch data to an operating system kernel in the AP 203. After processing the data, the operating system kernel invokes a display module to display an image corresponding to the touch event by frame.

The following describes in detail a specific implementation of the software program run on the MCU 202.

In some embodiments, when pre-processing the touch data, the MCU 202 is further configured to pre-process the touch data using a first frequency, where the first frequency is greater than a processing frequency of the AP. In an ANDROID system, the processing frequency of the AP is 60 Hz, and the first frequency used by the MCU 202 is 120 Hz.

Further, when pre-processing the touch data using the first frequency, the MCU 202 is further configured to determine, using the first frequency, a touch event corresponding to the touch data, where the touch event is one or more of a down event, a move event, or an up event.

In some embodiments, a down event corresponds to a down operation performed by a user on a touch panel of a mobile phone, a move (or slide) event corresponds to a move operation performed by the user from a position to another position on the touch panel, and an up event corresponds to an up operation performed by the user on the touch panel, that is, leaving the touch panel. These operations may be performed by a finger, or may be performed by a stylus or another touch device. Down, move, and up are only common names of the three events, and the present disclosure is not limited thereto.

It should be noted that, in some other embodiments, the touch event may be another event, for example, an event generated by a non-contact gesture.

Therefore, the MCU 202 processes the touch data using a processing frequency greater than that of the AP 203 such that an effective touch event can be recognized in a shorter period, and screen response performance can be improved.

In some embodiments, after determining, using the first frequency, the touch event corresponding to the touch data, the MCU 202 is further configured to determine, using the first frequency, a movement distance corresponding to the move event, and if the movement distance is greater than a first preset threshold in a system, send the move event to the AP 203, or if the movement distance is less than a first preset threshold in a system, not send the move event to the AP 203.

Therefore, the MCU 202 can rapidly process the move event, and recognize effective move in a shorter period such that a time of distinguishing and determining a tap event and a move event is reduced, and screen response performance can be further improved.

In some embodiments, the MCU 202 is further configured to determine whether a gesture corresponding to the touch event is the same as a screen-off wakeup gesture preset in a system when the touch panel is in a screen-off state, and if the gesture corresponding to the touch event is the same as the screen-off wakeup gesture preset in the system, send a wakeup instruction to the AP 203, or if the gesture corresponding to the touch event is different from the screen-off wakeup gesture preset in the system, not send a wakeup instruction to the AP 203.

Therefore, in this embodiment of the present disclosure, in a screen-off state, gesture recognition may be performed without the AP 203, and the MCU 202 determines the screen-off wakeup gesture. When the gesture is correct, the AP 203 in a sleep state is wakened up, or when the gesture is ineffective, the AP 203 in a sleep state is not wakened up, and the AP 203 may stay in a sleep state. However, in the other approaches, for most screen-off wakeup gestures, the AP is required for gesture recognition, and the AP cannot enable all kernels to enter a sleep state. Therefore, in comparison with the other approaches, in the present disclosure, a sleep of the AP 203 can be extended, and a case in which power consumption is generated after the AP 203 is wakened up by an incorrect screen-off wakeup gesture is avoided such that overall power consumption of a device can be reduced.

In some embodiments, the MCU 202 is further configured to obtain sensing data, and the MCU 202 is further configured to determine, according to the sensing data, whether the touch event is a misoperation event, and when the touch event is not a misoperation event, send the touch event to the AP 203, or when the touch event is a misoperation event, not send the touch event to the AP 203.

Optionally, when determining, according to the sensing data, whether the touch event is a misoperation event, the MCU 202 is further configured to determine whether illuminance measured by a light sensor is greater than a second preset threshold when the touch panel is in a screen-off state, and if the illuminance is not greater than the second preset threshold, determine that the touch event is a misoperation event.

In some embodiments, the MCU 202 is further configured to obtain sensing data, and when pre-processing the touch data and sending the pre-processed touch data to the AP 203, the MCU 202 is further configured to determine, according to the sensing data, whether an operation corresponding to the touch data is a misoperation, and if the operation is a misoperation, not process the touch data obtained from the touch panel, such as subsequent distinguishing of a touch event (down, move, and up), directly discard or ignore the touch data, and not report the touch data to the AP 203, or if the operation is not a misoperation, continue to perform a step such as distinguishing the touch event, perform other pre-processing on the touch data, and then report the pre-processed touch data to the AP 203.

Optionally, when determining, according to the sensing data, whether the operation corresponding to the touch data is a misoperation, the MCU 202 is further configured to determine whether illuminance measured by a light sensor is greater than a second preset threshold when the touch panel is in a screen-off state, and if the illuminance is not greater than the second preset threshold, determine that the operation corresponding to the touch data obtained by the MCU 202 from the touch panel is a misoperation.

Further, for obtaining data of a sensor, the MCU 202 may directly or indirectly obtain sensing data of the sensor by extending a function of the event processing module (EventHub).

In this way, the touch event of the touch panel can be pre-processed using the data of the sensor such that a misoperation event can be filtered. The AP 203 is not wakened up by a misoperation to some extent, that is, a case in which power consumption is generated after the AP 203 is wakened up by a misoperation is avoided. Therefore, overall power consumption of the AP 203 is effectively reduced, and power consumption of the terminal device is reduced.

In this embodiment of the present disclosure, the touch panel 201 communicates with the AP 203 using the MCU 202, instead of directly communicating with the AP 203. The MCU 202 pre-processes the touch data of the touch panel, and sends the processed data to the AP 203 such that the MCU 202 can process the touch data of the touch panel anytime when the AP 203 enters a sleep state, and the MCU 202 can filter the touch data. Therefore, in this solution of the present disclosure, the AP 203 without a task can enter a deep sleep state while system performance is not reduced, thereby reducing load of the AP 203, and reducing power consumption of a device.

A function of the MCU 202 in this embodiment of the present disclosure may be implemented using a coprocessor. A low function sensor hub (SensorHub) coprocessor in the other approaches may be used.

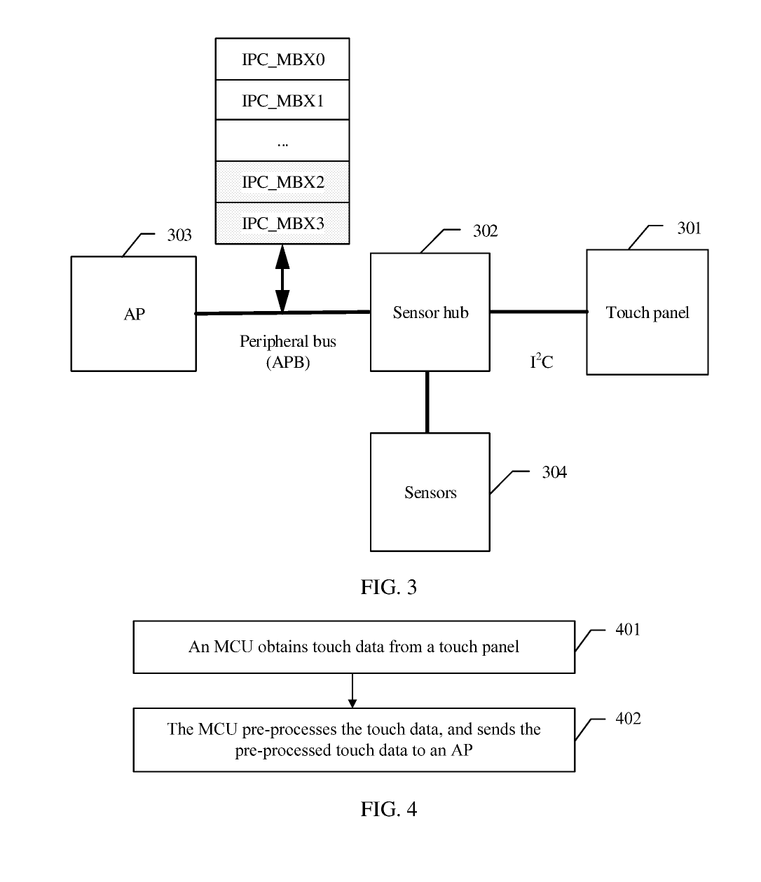

FIG. 3 is a schematic diagram of a principle of a hardware structure in which an MCU in an embodiment of the present disclosure and a sensor hub coprocessor in the other approaches are integrated.

An AP 303 is electrically connected to a sensor hub 302 using a peripheral bus, a touch panel 301 is electrically connected to the sensor hub 302 using an I²C bus, and the sensor hub 302 is connected to one or more sensors 304. Multiple registers are mounted on the peripheral bus. IPC_MBX0 and IPC_MBX1 are used for sensing data communication, and IPC_MBX2 and IPC_MBX3 are used for touch data communication. The two data transmission channels are dedicated data channels, and do not interfere with each other.

The sensor hub 302 has a function of the MCU 202 in the embodiment shown in FIG. 2, the AP 303 has a function of the AP 203 in the embodiment shown in FIG. 2, and the touch panel 301 has a function of the touch panel 201 in the embodiment shown in FIG. 2. Details are not described herein again.

In this embodiment of the present disclosure, the MCU is the sensor hub coprocessor, and a function of the MCU in this embodiment of the present disclosure can be implemented using a sensor hub in a conventional terminal device such that feasibility of this solution is improved. In addition, sensing data can be conveniently obtained, and a touch event of the touch panel is pre-processed using data of a sensor.

The following describes in detail a procedure of a method for processing data collected by a touch panel in an embodiment of the present disclosure with reference to FIG. 3. The method is performed by the MCU in the embodiment shown in FIG. 2 or the sensor hub coprocessor in the embodiment shown in FIG. 3.

Step 401. The MCU obtains touch data from a touch panel.

When a user touches the touch panel, the touch panel collects the touch data. The MCU obtains the touch data from the touch panel. A specific obtaining manner is as follows. The touch panel sends an interrupt request to the MCU using an interrupt controller, and the MCU obtains the touch data from the touch panel after receiving the interrupt request.

A touch panel driver in the MCU performs coordinate point calculation on the touch data to obtain touch data such as a touch coordinate point, and sends the touch data to an event processing module in the MCU.

Step 402. The MCU pre-processes the touch data, and sends the pre-processed touch data to an AP.

The event processing module in the MCU pre-processes the touch data after receiving the touch data sent by the touch panel driver, to filter an ineffective touch event, and sends the pre-processed touch data to the AP.

Further, the MCU pre-processes the touch data using a first frequency, and the first frequency is greater than a processing frequency of the AP. In an ANDROID system, the system sends a VSYNC signal (using about a 60 Hz frequency) every 16 ms to trigger the AP to process data, and therefore, the processing frequency of the AP is 60 Hz. A sampling frequency of the touch panel is 120 Hz, the MCU obtains the touch data from the touch panel, and therefore, a frequency for processing the touch data is consistent with the sampling frequency of the touch panel, and is 120 Hz. Therefore, the MCU can process the touch data using a processing frequency greater than that of the AP such that an effective touch event can be recognized in a shorter period, and screen response performance can be improved.

For a terminal device in the ANDROID system, a touch event is one or more of a down event, an up event, or a move event. In all operation events, a down operation (ACTION_DOWN) needs to be first performed, and the other subsequent operations are performed on the premise of the down operation. When the down operation is completed, a move operation (ACTION_MOVE) may be performed, and then an up operation (ACTION_UP) is performed, or when execution of the down operation is completed, an up operation is directly performed without a move operation. Therefore, a down action (ACTION_DOWN) needs to be first performed on the touch panel each time, and an up action (ACTION_UP) needs to be performed after user touch ends.

Further, that the MCU pre-processes the touch data is as follows. For the touch data, a touch event is first distinguished using the first frequency (120 Hz), and the touch data is determined as one or more of a down event, a move event, or an up event.

Then, that the MCU pre-processes the touch event further includes but is not limited to the following manners.

1. Rapidly Distinguish an Effective Move Event.

When the user touches the touch panel, the MCU distinguishes an event corresponding to the touch data using the first frequency (120 Hz). The MCU determines a move event (Move event) from detecting a down action (ACTION_DOWN), that is, a down event to detecting an up action (ACTION_UP), that is, an up event. In a specific move event determining process, in each sampling period, the MCU determines whether a movement distance corresponding to the user touch is greater than a first preset threshold in a system. If the movement distance is greater than the first preset threshold in the system, the MCU determines that the move event is an effective move event, and reports the move event to the AP, and the AP draws an image by invoking an imaging processing module, or if the movement distance corresponding to the user touch is not greater than the preset threshold in the system, the move event is an ineffective move event, and is not reported to the AP. Therefore, in this process, an ineffective move event (such as a finger shake or a relatively small movement distance) can be filtered.

It should be noted that herein, a movement distance corresponding to user touch in each period is a distance calculated starting from a down action (ACTION_DOWN) to an up action. In a screen-on state, when detecting a down event (ACTION_DOWN) and an up event (ACTION_UP), the MCU directly reports the down event and the up event to the AP.

Persons skilled in the art should understand that the first preset threshold provided in this embodiment of the present disclosure may be a movement distance determining threshold preset in the ANDROID system, and a common value is 4 ms, or may be set according to a specific empirical value. This is not limited herein.

In the other approaches of the ANDROID system, for the touch data, the AP distinguishes an event, the processing frequency of the AP is 60 Hz, and the processing frequency of the MCU is 120 Hz and is greater than the processing frequency of the AP. Therefore, in the present disclosure, the move event can be rapidly processed on the MCU side, and effective move is recognized in a shorter period such that a time of determining an effective move event is reduced, screen response performance can be further improved, and user experience can be improved.

2. Screen-Off Wakeup Gesture Processing.

If the terminal device supports a screen-off wakeup gesture function, when the touch panel is in a screen-off state, instead of directly reporting the touch event to the AP after obtaining the touch event, the MCU first determines whether a user move gesture corresponding to the touch event is the same as a screen-off wakeup gesture preset in a system. If the user move gesture is the same as the screen-off wakeup gesture, a wakeup instruction is generated and the wakeup instruction is sent to the AP. The wakeup instruction is used to wake up the AP such that the AP lights up a screen. If the user move gesture is different from the screen-off wakeup gesture, a wakeup instruction is not sent to the AP, that is, the touch event is filtered and is not reported to the AP. Therefore, the AP may stay in a sleep state, and the AP is not wakened up by an incorrect screen wakeup gesture operation. That is, a case in which power consumption is generated after the AP is wakened up by an incorrect screen-off wakeup gesture is avoided, thereby effectively reducing overall power consumption of the AP, and reducing power consumption of the terminal device.

3. Filter a Touch Event Using Sensing Data.

The MCU obtains sensing data in addition to the touch data of the touch panel, determines, according to the sensing data, whether the touch event is a misoperation event, and if the touch event is a misoperation event, does not send the touch event to the AP, or if the touch event is not a misoperation event, sends the touch event to the AP.

For example, when the touch panel is in a screen-off state, if the MCU detects a touch event, the MCU determines the touch event using currently obtained data of a light sensor. A specific determining manner is as follows. It is determined whether illuminance measured by the light sensor is greater than a second preset threshold, and if the illuminance is not greater than the second preset threshold, it is determined that the current touch event is a misoperation event.

Optionally, after obtaining the touch data, for the touch data, the MCU does not perform the step of distinguishing the touch event using the first frequency (120 Hz) and determining the touch data as one or more of a down event, a move event, or an up event. Instead, the MCU first determines, according to the sensing data, whether the touch operation is a misoperation, and if the touch operation is a misoperation, does not process the touch data, such as subsequent distinguishing of a touch event, discards or ignores the touch data, and does not report the touch data to the AP, or if the touch operation is not a misoperation, continues to perform a step such as distinguishing the touch event, performs other pre-processing on the touch data, and then reports the pre-processed touch data to the AP

Further, if the touch panel is in a screen-off state, the MCU determines whether illuminance measured by the light sensor is greater than a second preset threshold, and if the illuminance is not greater than the second preset threshold, determines that an operation corresponding to the touch data obtained by the MCU from the touch panel is a misoperation operation.

A specific application scenario is used as an example for description. When the terminal device (for example, a mobile phone) is put in a pocket of a user and is in a screen-off state, the user slides a screen of the mobile phone due to a misoperation. In this case, the MCU obtains illuminance data measured by a current light sensor, and because the terminal device is currently in the pocket, the illuminance data is less than a second preset threshold set in a system. Therefore, it is determined that the mobile phone is in a place with weak light, it is further determined that the slide action is a misoperation, and the misoperation is not reported to the AP. In this way, the AP is not wakened up by the misoperation.

Persons skilled in the art should understand that the second preset threshold provided in this embodiment of the present disclosure may be set according to experience, or may be set by collecting illuminance data in different light situations and analyzing the illuminance data. For example, if all illuminance data collected in weak light is less than A by means of analyzing, the second preset threshold may be set to A. A value of A is usually 7 lux.

Therefore, in this embodiment of the present disclosure, the MCU may obtain sensing data of a sensor, and determine the touch operation according to the sensing data. If the touch operation is a misoperation, the touch operation is not reported to the AP, and the misoperation is filtered by means of pre-processing such that the AP is not wakened up by the misoperation to some extent, that is, a case in which power consumption is generated after the AP is wakened up by the misoperation is avoided, thereby effectively reducing overall power consumption of the AP, and reducing power consumption of the terminal device.

In conclusion, in this embodiment of the present disclosure, the MCU pre-processes the touch data of the touch panel to filter ineffective touch data, and then sends effective touch data to the AP. The MCU can process the touch data of the touch panel anytime when the AP enters a sleep state, and the MCU can filter the touch data such that the AP is not wakened up by an ineffective touch event and a misoperation event when the AP enters a sleep state, and power consumption can be effectively reduced. In addition, the MCU can process the touch data using a frequency greater than the processing frequency of the AP such that an effective touch event can be recognized in a shorter period, screen response performance can be improved, and user experience is improved.

In the specification, claims, and accompanying drawings of the present disclosure, the terms “first,” “second,” “third,” “fourth,” and so on (if existent) are intended to distinguish between similar objects but do not necessarily indicate a specific order or sequence. It should be understood that the data termed in such a way are interchangeable in proper circumstances so that the embodiments of the present disclosure described herein can be implemented in other orders than the order illustrated or described herein. Moreover, the terms “include,” “contain” and any other variants mean to cover the non-exclusive inclusion, for example, a process, method, system, product, or device that includes a list of steps or units is not necessarily limited to those units, but may include other units not expressly listed or inherent to such a process, method, system, product, or device.

In the several embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the other approaches, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

1. A method for processing data comprising comprising:
obtaining by a micro control unit (MCU) touch data from a touch panel, the touch panel communicating with an application processor through the MCU;
pre-processing, by the MCU, the touch data; and
sending, by the MCU, the preprocessed touch data to the application processor.

2. The method of claim 1, wherein sending the pre-processed touch data to the application processor comprises sending, by the MCU, the pre-processed touch data to the application processor through a touch data channel, and the touch data channel being configured to send only the pre-processed touch data.

3. The method of claim 2, wherein pre-processing the touch data comprises pre-processing, by the MCU, the touch data based on a first frequency, and the first frequency being greater than a processing frequency of the application process.

4 The method of claim 3, wherein pre-processing the touch data based on the first frequency comprises determining, by the MCU, a touch event corresponding to the touch data based on the first frequency, and the touch event comprising one of a down event, a move event, or an up event.

5. The method of claim 4, wherein when the touch event comprises the move event, pre-processing the touch data based on the first frequency further comprises determining, by the MCU, a movement distance corresponding to the move event and, sending the pre-processed touch data comprising sending, by the MCU, the move event to the application processor when the movement distance is greater than a first preset threshold.

6. The method of claim 4, wherein pre-processing the touch data based on the first frequency further comprises determining, by the MCU, whether a gesture corresponding to the touch event is the same as a preset wakeup gesture when the touch panel is in a screen-off state, sending the pre-processed touch data to the application processor comprising sending, by the MCU, a wakeup instruction to the application processor when the gesture corresponding to the touch event is the same as the preset wakeup gesture.

7. The method of claim 4, further comprising obtaining, by the MCU, sensing data of a sensor, and sending the pre-processed touch data comprising sending, by the MCU, the touch event to the application processor when the sensing data meets a present condition.

8. The method of claim 7, wherein the sensor comprises a light sensor, and the method further comprising continuing to keep the touch panel in a screen-off state when the touch panel is in the screen-off state and an illuminance measured by the light sensor is not greater than a second preset threshold.

9. A terminal device, comprising:
a touch panel configured to collect touch data;
a micro control unit (MCU) electrically coupled to the touch panel and configured to:
obtain the touch data;
pre-process the touch data; and
send the pre-processed touch data to an application processor, and
he application processor being electrically coupled to the MCU and configured to perform event response according to the touch data received from the MCU.

10. The terminal device of claim 9, wherein the application processor is electrically coupled to the MCU using a peripheral bus, and the touch panel being electrically coupled to the MCU using an inter-integrated circuit bus (I²C).

11. The terminal device of claim 9, further comprising a touch data channel electrically coupled to a peripheral bus, the touch data channel being configured for data communication only between the MCU and the application processor, and the MCU being further configured to send the pre-processed touch data to the application processor using the touch data channel.

12. The terminal device of claim 11, wherein when pre-processing the touch data, the MCU is further configured to pre-process the touch data using a first frequency, and the first frequency being greater than a processing frequency of the application processor.

13. The terminal device of claim 12, wherein when pre-processing the touch data using the first frequency, the MCU is further configured to determine, using the first frequency, a touch event corresponding to the touch data, and the touch event comprising one or more of a down event, a move event, or an up event.

14. The terminal device of claim 13, wherein after determining the touch event corresponding to the touch data, the MCU is further configured to:
determine, using the first frequency, a movement distance corresponding to the move event when the event corresponding to the touch data comprises the move event; and
send the move event to the application processor when the movement distance is greater than a first preset threshold in a system.

15. The terminal device of claim 13, wherein after determining the touch event corresponding to the touch data, the MCU is further configured to:
determine whether a gesture corresponding to the touch event is the same as a screen-off wakeup gesture preset in a system when the touch panel is in a screen off state; and
send a wakeup instruction to the application processor when the gesture corresponding to the touch event is the same as the screen-off wakeup gesture preset in the system.

16. The terminal device of claim 13, wherein the MCU is further configured to:
obtain sensing data; and
determine, according to the sensing data and after determining the touch event corresponding to the touch data, whether the touch event comprises a misoperation event; and
send the touch event to the application processor when the touch event does not comprise the misoperation event.

17. The terminal device according to claim 16, wherein when determining whether the touch event comprises the misoperation event, the MCU is further configured to:
determine whether illuminance measured by a light sensor is greater than a second preset threshold when the touch panel is in a screen-off state; and
determine that the touch event comprises the misoperation event when the illuminance is not greater than the second preset threshold.

18. The terminal device of claim 9, wherein the MCU comprises a low function sensor hub coprocessor.
